(19) United States
(12) Patent Application Publication
(10) Pub. No.: US 2024/0369435 A1
(43) Pub. Date: Nov. 7, 2024

(54) MEMBRANE SENSOR FOR COMPENSATING FOR AN ACCELERATION, AND METHOD FOR GENERATING A COMPENSATED SENSOR SIGNAL

(71) Applicant: Robert Bosch GmbH, Stuttgart (DE)

(72) Inventors: Johannes Classen, Reutlingen (DE); Andreas Scheurle, Leonberg (DE); Manuel Glas, Kirchentellinsfurt (DE)

(21) Appl. No.: 18/630,460

(22) Filed: Apr. 9, 2024

(30) Foreign Application Priority Data
May 2, 2023 (DE) 10 2023 204 039.5

(51) Int. Cl. G01L 19/00; G01L 9/00; G01P 15/125

(52) U.S. Cl. CPC G01L 19/0092; G01L 9/0072; G01P 15/125

(57) ABSTRACT

A membrane sensor. The membrane sensor includes: a pressure sensor configured to generate a first sensor signal depending on a deflection of a pressure-loadable membrane; an acceleration sensor configured to generate a second sensor signal depending on an acceleration acting on a MEMS functional structure; and an evaluation circuit configured to compensate for a dependence of the first sensor signal on an acceleration force, in particular weight force, acting on the membrane, based on the second sensor signal. The pressure sensor and the acceleration sensor are stacked one above the other in a z direction. A method for generating a compensated sensor signal using such a membrane sensor is also described.

### CROSS REFERENCE

The present application claims the benefit under 35 U.S.C. § 119 of German Patent Application No. DE 10 2023 204 039.5 filed on May 2, 2023, which is expressly incorporated herein by reference in its entirety.

### FIELD

The present invention relates to micromechanical sensors, in particular micromechanical acceleration sensors and pressure sensors.

### BACKGROUND INFORMATION

Micromechanical sensors are in particular widely used in the field of automotive technology and in the field of consumer electronics. Micromechanical acceleration sensors typically have a MEMS functional structure (microelectromechanical system, microsystem) designed to detect an acceleration acting on it.

European Patent No. EP 0 244 581 A1 describes, for example, a sensor for automatically triggering an occupant protection device, in which sensor the housing consists of a small silicon plate, out of which two identical pendulums with asymmetrically formed rotating masses are carved in an etching technique.

European Patent No. EP 0 773 443 describes a micromechanical acceleration sensor comprising a first electrode on a first semiconductor wafer and a movable second electrode on a second semiconductor wafer. A microelectronic evaluation unit is arranged on the first semiconductor wafer.

Micromechanical pressure sensors are often exposed directly to the medium whose physical and/or chemical properties are to be detected. In order to increase the media robustness, it is common in the related art to protect sensitive sensor structures with a gel in order to prevent corrosion and/or deposition of unwanted adsorbates.

However, such a gel can in particular adversely affect the accuracy of the pressure detection. Against the background of ever increasing requirements with regard to sensor sensitivity, there is great interest in bringing about as much compensation as possible for such forces acting on the membrane of micromechanical pressure sensors.

### SUMMARY

It is an object of the present invention to provide a membrane sensor in which deviations caused by acceleration forces and/or inertial forces, in particular a g-sensitivity, are at least partially compensated. It is also an object of the present invention to specify a method for generating a sensor signal compensated for such an influence.

The aforementioned object may be achieved by features of the present invention. Advantageous configurations of the present invention are disclosed herein.

According to an example embodiment of the present invention, a micromechanical membrane sensor comprises a pressure sensor and an acceleration sensor. The pressure sensor comprises a membrane which can be loaded with a pressure, in particular ambient pressure, of a gas or fluid surrounding the membrane sensor. The pressure sensor is configured to generate, for example capacitively or piezoresistively, a first sensor signal depending on a deflection of the membrane. The acceleration sensor has a MEMS functional structure and is configured to generate a second sensor signal depending on an acceleration acting on the MEMS functional structure. An electronic evaluation circuit is furthermore configured to compensate for a dependence of the first sensor signal on an acceleration force, in particular weight force, acting on the membrane, on the basis of the second sensor signal. It is provided that the pressure sensor and the acceleration sensor are arranged stacked one above the other in a z direction.

A feature of the present invention is thus an arrangement in which the pressure sensor and the acceleration sensor are arranged stacked one above the other in the z direction, in particular perpendicularly to the main extension plane of the semiconductor substrates, so that the membrane is in close proximity to the MEMS functional structure of the acceleration sensor. The influence of the acceleration on the membrane can thus be detected directly and accordingly be taken into account in the pressure detection. Accordingly, the pressure sensor and the acceleration sensor are read and connected to one another in such a way that the g-sensitivity of the pressure sensor is compensated on the basis of the sensor signal of the acceleration sensor.

An integration of the pressure sensor and of the acceleration sensor at the chip level is not required in such an arrangement. The provided arrangement of acceleration sensor and pressure sensor according to the present invention thus advantageously makes it possible to separately produce the sensors in different production lines, which can be optimized differently for different manufacturing processes, resulting in lower overall production costs. Such a separation of the manufacturing processes is advantageous since a chip-based integration typically requires compromises in design and in process technology. Typically, the functional layer thicknesses commonly used to form the two sensor types differ significantly from one another: For a pressure sensor, typical membrane thicknesses range from 1 μm to 10 μm, whereas MEMS functional structures with masses and springs are generally formed from functional layers that are 10 μm to 30 μm thick. Caverns of pressure sensors are also typically only loaded with a low internal pressure of less than 20 mbar in order to avoid possible signal errors due to the temperature dependence of the pressure of the included gas, whereas MEMS functional structures of acceleration sensors should generally be damped and therefore operate at higher internal pressures in the range of, for example, 50 to 1000 mbar. The pressure sensor or the acceleration sensor can in particular be produced comparatively simply and cost-effectively using known process technology. The manufacturing processes can be optimized, separately from one another, for both types of sensors in an advantageous manner with respect to the respective requirements, in particular with regard to the provided signal quality (for example, noise, offset errors or sensitivity errors).

Within the scope of this disclosure, a compensation for the g-sensitivity is understood to mean the compensation for interference variables caused in the narrower sense by a weight force. The disclosure is however not limited thereto. In a broader sense, the compensation for the g-sensitivity is understood to mean any compensation for interference variables generally caused by accelerations that are detectable by the acceleration sensor. In particular, this definition also includes inertial forces, such as centrifugal forces, in which no weight force acts on the membrane or the gravitational field of the earth is not involved.

In an advantageous configuration of the present invention, the membrane of the pressure sensor is arranged in a plane perpendicular to the z direction, in particular parallel to the main extension plane of a semiconductor substrate assigned to the pressure sensor. The MEMS functional structure is preferably designed to detect at least one acceleration component that acts in the z direction and on the MEMS functional structure. In one configuration, the MEMS functional structure is structurally designed, for example by restricting the mechanical degrees of freedom of the micromechanical system, in such a way that only the acceleration component acting in the z direction is selectively detectable. For an efficient compensation for the deflection of the membrane that is caused by the acceleration forces and/or inertial forces, it is in particular advantageous if at least a detection of the acceleration component in a direction perpendicular to the membrane plane, i.e., in the z direction, takes place.

In one configuration of the present invention, the MEMS functional structure of the acceleration sensor and the membrane of the pressure sensor are arranged superposed at least in regions. For example, the MEMS functional structure is arranged in a functional layer of the acceleration sensor below the membrane of the pressure sensor such that the MEMS functional structure and the membrane overlap in the z direction at least in regions. A spatial arrangement in close proximity to one another, preferably in the region of the center of gravity of the stacked membrane sensor, is advantageous since, as a result, deflections of the membrane that are caused by acceleration forces or inertial forces can be effectively detected and accordingly compensated.

In order to increase the robustness to gases and/or fluids surrounding the membrane sensor, it is provided in configurations of the present invention to cover at least the membrane and possibly further sensitive sensor structures, such as bonding wires or the like, with a gel. The applied gel is suitable for transferring an ambient pressure to the membrane and, in such configurations, typically exerts a non-negligible weight force on the membrane, which varies depending on the orientation of the membrane sensor in the gravitational field of the earth. Thus, depending on its orientation, the pressure sensor registers apparent pressure changes that are reflected in the first sensor signal. Likewise, the second sensor signal detected by the acceleration sensor represents these variations dependent on the orientation of the membrane sensor, so that the second sensor signal, where appropriate after suitable phase adjustment, can be used to compensate for the interference variables, caused by the movement and/or orientation of the membrane sensor, in the first sensor signal at least on average. This can take place in configurations in particular at the analog or digital circuit level.

In advantageous configurations of the present invention, the pressure sensor and the acceleration sensor are similar transducers. For example, the pressure sensor and the acceleration sensor are each designed as capacitive transducers or as piezoresistive transducers. The use of similar transducer types advantageously makes it possible to compensate for the first sensor signal on the basis of the second sensor signal, in particular at the analog circuit level. Accordingly, in such configurations, the evaluation circuit is preferably designed, in particular for compensating for the g-sensitivity, to generate an analog sum signal of the first sensor signal of the pressure sensor and the second sensor signal of the acceleration sensor. This can in particular be achieved in that a bonding wire, which taps a change in capacitance of the pressure sensor, and a further bonding wire, which taps a change in capacitance of the acceleration sensor, extend onto one and the same bond pad. It is understood that configurations in which first and second sensor signals, which, for example, reflect pressure sensor capacitances and acceleration sensor capacitances, are tapped and suitably electrically connected with more than one bonding wire are also possible.

In advantageous configurations of the present invention, the compensation for the g-sensitivity preferably takes place at the digital circuit level, in particular by means of an integrated circuit in an ASIC chip.

Preferably, the evaluation circuit comprises at least one analog front end (AFE) for converting and/or processing analog signals. Particularly preferably, the evaluation circuit, in particular the integrated circuit, comprises at least a first analog front end assigned to the first sensor signal and a second analog front end assigned to the second sensor signal. In configurations in which separate analog front ends are provided for the acceleration sensor and for the pressure sensor, these sensors can be transducers of different types and can, for example, be designed as piezoresistive and/or capacitive transducers. For example, it is possible in such configurations to use a piezoresistive pressure sensor in combination with a capacitive acceleration sensor for signal correction since the signal correction only takes place after A/D conversion, i.e., for example in the digital part of the ASIC chip, in particular by means of a microcontroller.

In configurations of the present invention, the evaluation circuit comprises a multiplexer for reading the first and second sensor signals at different times. In such embodiments, the evaluation circuit is, for example, designed to alternately read a capacitive pressure sensor and a capacitive acceleration sensor by means of the multiplexer and to internally offset the thereby obtained first and second sensor signals against one another. With a suitable design of the properties of the two sensors, in particular with regard to a sensitivity, a useful capacitance, and/or parasitic capacitance, the same analog front end can thus be used for both sensors and a correspondingly simplified evaluation circuit, in particular in the ASIC chip, can be realized.

In configurations of the present invention, the evaluation circuit is at least partially realized as an integrated circuit in the aforementioned ASIC chip. In configurations in which a compensation takes place, as already described above, by directly connecting the pressure sensor and the acceleration sensor, the already compensated sensor signal can in particular be transferred to the input of the circuit integrated in the ASIC chip. The acceleration sensor is preferably arranged in the z direction between the ASIC chip and the pressure sensor so that the stacked arrangement of the ASIC chip, acceleration sensor, and pressure sensor has a compact design overall, preferably with a center of gravity that is in particular located in the region of the MEMS functional structure.

In possible configurations of the acceleration sensor of the present invention, the MEMS functional structure comprises a spring/mass system, in particular in the form of a rocker structure. In this rocker structure, at least one mass is connected to at least one spring element, wherein the at least one mass comprises a movable electrode, in particular of a capacitive measurement value detection for detecting the acceleration acting on the MEMS functional structure.

In particular, the spring/mass system can comprise a further (second) mass, which is likewise connected to the at least one spring element. In one configuration of the present invention, the further mass can be connected to the same spring element as the first mass; in particular, the masses can be arranged at the two opposite ends or sides of the spring element. It is likewise possible that the second mass comprises a movable electrode that is part of a further capacitive measurement value detection for detecting the acceleration acting on the MEMS functional structure. Optionally, it may be provided that the two masses are of the same size or are different from one another. In this case, the second mass can be heavier than the first mass by a factor of 2, 5, or 10. Through such an asymmetrical configuration of the two masses, it can be achieved that the second mass moves in the same direction as the membrane mass, whereby, as a result of the suspension of the second mass, for example in the form of a rocker structure, the first mass moves in the opposite direction. This results in a greater distance of the electrodes in the second measurement capacitance of the first mass, whereby, with a corresponding dimensioning of the spring/mass system, the thus detected second sensor signal can be used as a measure of the acting acceleration and for compensating for the first sensor signal of the pressure sensor.

The spring element of the MEMS functional structure can, for example, be arranged in the same plane as the two masses. It is also possible for the spring element to be designed as a flexible spring, a torsion spring, or a bending beam.

According to an example embodiment of the present invention, the pressure sensor, for example, comprises a capacitive measurement value detection for detecting a pressure, in particular ambient pressure. In this case, the deflection of the membrane is in particular detected capacitively.

The second sensor signal of the acceleration sensor can in particular be used as the weight force compensation variable for the first sensor signal. In so doing, the second sensor signal can be separately detected and taken into account in the evaluation of the first sensor signal.

In configurations, the capacitive measurement value detections of the pressure sensor and the acceleration sensor are electrically connected to one another in pairs or sequentially in such a way that a compensated sensor signal is generated from the capacitively detected first sensor signal and the capacitively detected second sensor signal, in particular such that a separate evaluation is not necessary. It is possible, for example, to electrically connect the capacitive measurement value detection of the pressure sensor and the capacitive measurement value detection of the acceleration sensor by suitable wiring directly in the sensor structure so that a sum of useful capacitance and compensation capacitance is formed directly at the level of the sensors.

According to an example embodiment of the present invention, a method for generating the compensated sensor signal preferably takes place using the above-described membrane sensor such that it comprises at least the following steps:
generating the first sensor signal depending on the deflection of the pressure-loadable membrane of the pressure sensor;
generating the second sensor signal depending on the acceleration acting on the MEMS functional structure of the acceleration sensor; and
generating the compensated sensor signal in that the dependence of the first sensor signal on the acceleration force, in particular weight force, acting on the membrane is compensated on the basis of the second sensor signal.

The above- and below-described sensor system for compensating for the g-sensitivity can inter alia be used in connection with mobile devices, such as smartphones and tablets, wearables or hearables. Further areas of application are augmented or virtual reality, drones, gaming and toys, robots or smart home. In the industrial context, the membrane sensor or the method described here for compensating for the g-sensitivity can inter alia be used for the following applications:
HMI functionality (human machine interface), e.g., multi-tap detection, activity detection, gesture and context detection, user detection;
motion control, gimbal system, altitude and location stabilization, flight control, image stabilization, interior and exterior navigation, floor detection, position tracking and route recording, PDR (pedestrian dead reckoning), dynamic route planning, boundary and obstacle detection, indoor SLAM (simultaneous localization and mapping);
intrusion monitoring, real-time motion detection and tracking, activity tracking, calorie counter;
logistics, parts tracking, energy management and energy-saving measurement, predictive maintenance;
air quality and climate monitoring, mold detection, water level detection;
sensor data fusion.

In the field of the automotive industry, the following applications are favorable, for example:
crash detection, e.g., in airbag systems;
navigation applications;
optimization of the engine control and the combustion process in gasoline- or diesel-powered engines.

Further details and advantages of the present invention are explained in more detail below with reference to the exemplary embodiments shown in the figures.

### BRIEF DESCRIPTION OF THE DRAWINGS

FIG. 1 shows a schematic plan view of a membrane sensor comprising a pressure sensor and an acceleration sensor, according to an example embodiment of the present invention.

FIG. 2 shows a schematic sectional view of the membrane sensor of FIG. 1.

FIG. 3 shows an evaluation circuit for generating a compensated sensor signal with separate analog front ends, according to an example embodiment of the present invention.

FIG. 4 shows an evaluation circuit for generating a compensated sensor signal with a multiplexer, according to an example embodiment of the present invention.

FIG. 5 shows a schematic sectional view of a pressure sensor according to a possible exemplary embodiment of the present invention.

FIG. 6 shows a schematic sectional view of an acceleration sensor according to a possible exemplary embodiment of the present invention.

### DETAILED DESCRIPTION OF EXAMPLE EMBODIMENTS

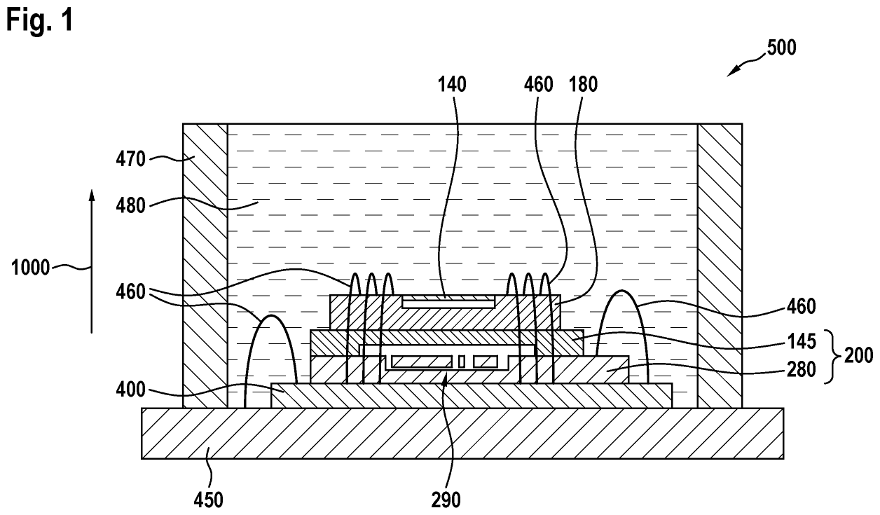

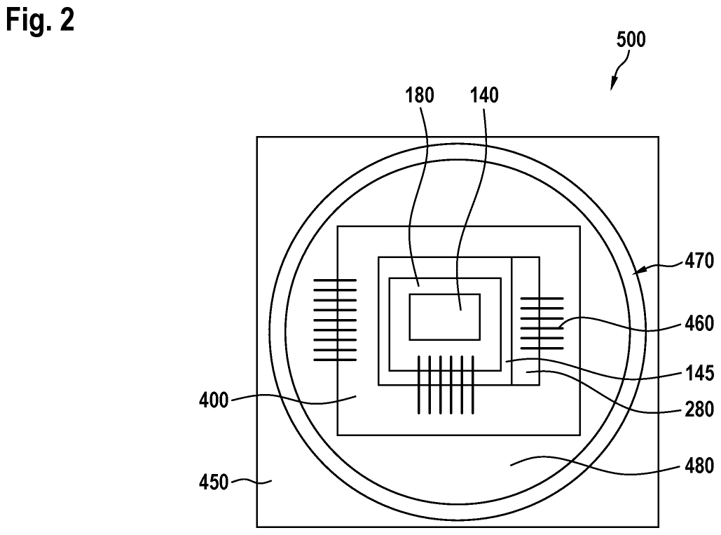

FIG. 1 shows a membrane sensor 500 according to a possible exemplary embodiment in a simplified sectional view; FIG. 2 shows the same arrangement in a plan view in the z direction 1000. The membrane sensor 500 comprises a pressure sensor 180, an acceleration sensor 200, and an ASIC chip 400 in an arrangement stacked one above the other in the z direction 1000.

According to possible exemplary embodiments, the pressure sensor 180 and/or the acceleration sensor 200 are sensors with a piezoresistive or capacitive operating principle. The ASIC chip 400 is attached to a printed circuit board 450 by means of a suitable adhesive, for example a DAF (die attach film), a liquid adhesive or a soft silicone adhesive. Accordingly, the acceleration sensor 200 is attached to the pressure sensor 180, and the pressure sensor 180 is attached to the ASIC chip 400.

In the exemplary embodiment shown, the acceleration sensor 200 comprises a cover 145 and a substrate 280.

In the exemplary embodiment shown, the electrical connection between the pressure sensor 180, the acceleration sensor 200, and the ASIC chip 400 on the one hand (internal connections) and between the ASIC chip 400 and the printed circuit board 450 on the other hand (external connections) takes place in each case via bonding wires 460.

A possible alternative to the shown bonding wires 460 is, for example, so-called through-silicone vias (TSVs), which connect the pressure sensor 180, the acceleration sensor 200, and the ASIC chip 400 to one another. As further alternatives, 3D-like rewiring can be provided, in which electrical connections extend in particular via the side surfaces of the components 180, 200, 400 onto the underlying printed circuit board 450 or an underlying semiconductor chip. As an alternative to contacting by means of bonding wires 460, a flip-chip approach is also possible, in which the ASIC chip 400, with the functional side down, is mechanically and electrically contacted by means of solder balls on the printed circuit board 450. In this case, the electrical connection would, for example, be made by bonding wires that extend on the printed circuit board 450 and are electrically connected to the contacts of the ASIC chip 400 via conductive paths.

In the exemplary embodiment shown, an in particular cylindrical housing wall 470 is furthermore arranged on the printed circuit board 450 on the edge around the stacked arrangement of the ASIC chip 400, pressure sensor 180, and acceleration sensor 200. In possible applications, the housing wall 470 serves to fix the membrane sensor 500 to an end device, for example a smartphone or a smartwatch.

The housing wall 470 forms a cavity filled with a gel 480. In particular, the gel 480 surrounds a pressure-sensitive membrane 140 of the pressure sensor 180 in order to protect the membrane from direct contact with moisture, liquids, particles, or the like. The gel is typically introduced at the end of the manufacturing process and covers not only the pressure sensor 180, the acceleration sensor 200, and the ASIC chip 400 but also the bonding wires 460 and/or further electrical contacts (not shown in detail) in order to protect these sensitive components from environmental influences.

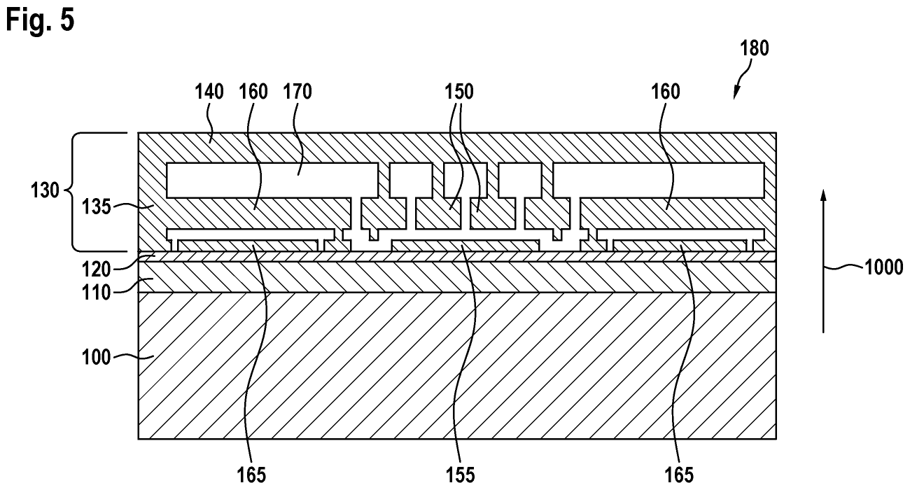

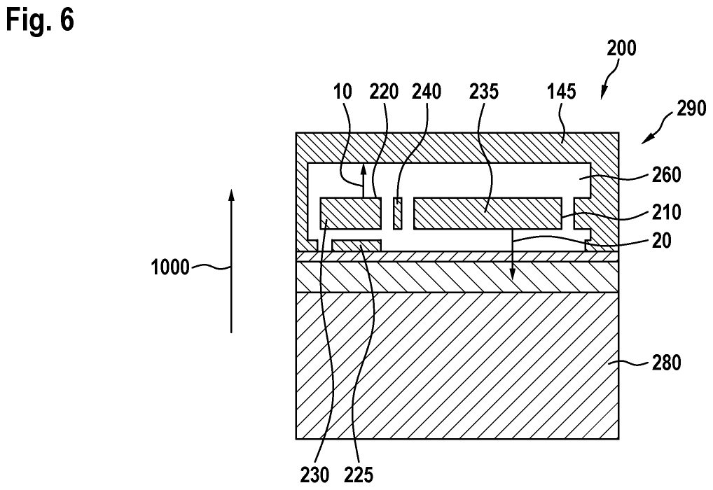

As shown in FIG. 1 in a sectional view and in FIG. 2 in a plan view in the z direction 1000, a MEMS functional structure 290 of the acceleration sensor 200 is located in a region directly below the membrane 140 and advantageously approximately in the region of the center of gravity of the membrane sensor 500. The MEMS functional structure 290 of the acceleration sensor 200 and the membrane 140 thus overlap at least in regions in the z direction 1000. The MEMS functional structure 290 is designed to detect an acceleration acting on it, and typically comprises micromechanical oscillators in the form of masses and springs for this purpose. An exemplary configuration of a suitable capacitive pressure sensor 180 is shown in FIG. 5; an exemplary configuration of a suitable capacitive acceleration sensor 200 is shown in FIG. 6.

Depending on the orientation in the gravitational field of the earth, the gel 480 exerts a variable weight force on the membrane 140. As a result of a rotation of the membrane sensor 500, an apparent pressure change, which is reflected in a first sensor signal 1100 generated by the pressure sensor 180, is thus typically registered. For compensating for such effects, a second sensor signal 1200 generated by the acceleration sensor 400 is used, which is generated depending on the acceleration acting on the MEMS functional structure 290.

The signal changes S_{Press} of the pressure sensor 180 and the signal changes S_{Accel} of the acceleration sensor 200 can be offset against one another or connected to one another by means of an evaluation circuit 600 in order to generate a compensated sensor signal 1300 according to S_{Comp}=S_{Press}+S_{Accel}. In this case, the acceleration sensor 200 can be designed such that the signal change is opposite to the action of the weight force of the gel on the membrane 140.

In the case of capacitive pressure sensors 180, the first and second sensor signals can be transferred, already compensated on the input side by suitable electrical connection of the pressure sensor and of the acceleration sensor 180, 200, to the circuit integrated in the ASIC chip 400. This can in particular be achieved in that the at least one bonding wire 460, which taps a change in capacitance C_{Press} of the membrane 140, and at least one bonding wire 460, which taps a change in capacitance C_{Accel} of the acceleration sensor 200, extend onto the same bond pad.

In this case, the integrated circuit implemented in the ASIC chip 400 will only detect, at the input, the sum signal of the capacitances, i.e., dC=C_{Press}+C_{Accel}.

With the aforementioned embodiment, a compensation for or at least significant reduction of the g-sensitivity can thus be achieved. It is in particular possible to compensate for the mean value of the g-sensitivity. Furthermore advantageous is the simplicity of the arrangement since the compensation for the acceleration effects can already take place in an evaluation circuit 600 prior to the signal processing in the ASIC chip 400. In particular, no additional analog front end (AFE), i.e., no additional signal processing circuit, is required in the ASIC chip 400 for the acceleration sensor 200. The compensation effect advantageously also works for other accelerations not caused by gravity.

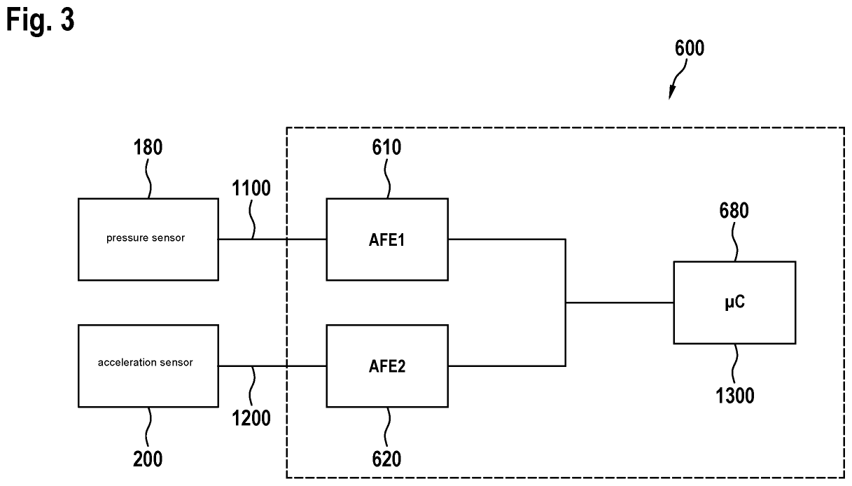

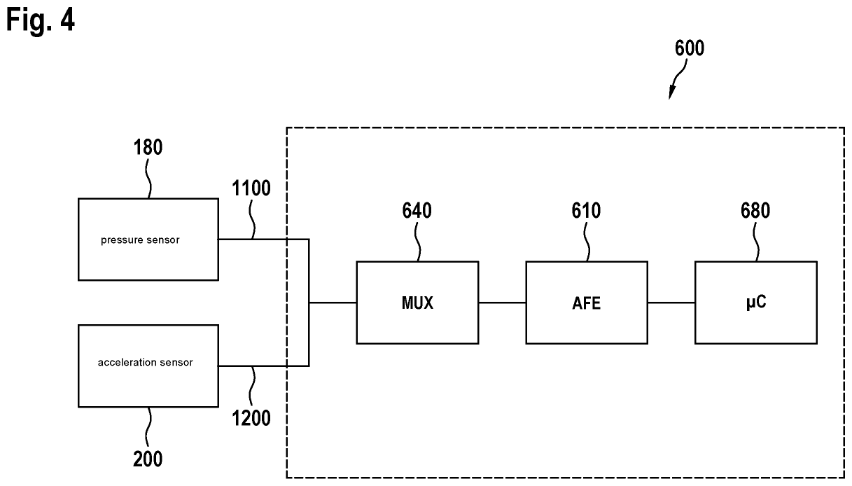

FIGS. 3 and 4 show further exemplary embodiments of the evaluation circuit 600 for compensating for the g-sensitivity. The evaluation circuit 600 of FIGS. 3 and 4 is implemented at least in part in the ASIC chip 400. The evaluation circuit 600 shown in particular makes a fine adjustment of the compensation effect with regard to tolerances possible. Such tolerances in the g-sensitivity can, for example, be produced for manufacturing-related reasons due to different fill quantities of the gel 480; otherwise, the pressure sensor 180 and/or the acceleration sensor 200 can also have manufacturing-related tolerances, which manifest, for example, in different membrane stiffness due to layer thickness tolerances, in different layer stresses, and/or in a variability of the electrode gap.

FIG. 3 shows a simplified block diagram of an embodiment in which the pressure sensor 180 is not directly connected to the acceleration sensor 200. The first sensor signals 1100 provided by the pressure sensor 180 and the second sensor signals 1200 provided by the acceleration sensor 200 are supplied to the electrical evaluation circuit 600 on separate evaluation paths. The evaluation circuit 600 implemented in the ASIC chip 400 comprises a respective analog front end 610, 620 for the first sensor signal 1100 of the pressure sensor 180 and for the second sensor signal 1200 of the acceleration sensor 200.

For generating the compensated sensor signal 1300, the evaluation circuit 600 implements in particular an evaluation according to dC=C_{Press}−V C_{Accel}, wherein the compensation factor V can be determined in a component-specific manner during the final calibration of the membrane sensor 500 or, where appropriate, of the end device in which the membrane sensor 500 is installed, and can be calibrated accordingly.

In the exemplary embodiment shown, the signal correction of the pressure sensor 180 takes place by means of a computing unit 680, for example a microcontroller, integrated in the ASIC chip 400, after A/D conversion.

In the embodiment shown in FIG. 4, the evaluation circuit 600 is designed to alternately read a capacitive pressure sensor 180 and a capacitive acceleration sensor 200 by means of a multiplexer 640 and to internally offset the corresponding first and second sensor signals 1100, 1200 against one another. A suitable design of the sensor parameters makes it possible to use the same analog front end 610 for the pressure sensor 180 and for the acceleration sensor 200.

For a component-specific compensation, it is favorable, for calibrating the membrane sensor 500, to apply an acceleration stimulus in or to determine the compensation factor V and store it, for example, in a calibration register so that the compensation for the g-sensitivity can be calculated with a microcontroller or processor which is internal or external to the sensor.

Depending on the accuracy requirements with respect to the compensation, a component-specific electrical self-test of pressure sensor 180 and acceleration sensor 200 may also be sufficient in some circumstances, for example by means of a step response when an electrical test signal is impressed on the membrane 140 of the pressure sensor 180 or on a seismic mass of the acceleration sensor 200. From the course of the step response or, more generally, of the electrical test signal response, the acceleration sensitivity of the membrane 140 and of the acceleration sensor 200 can be ascertained at least approximately, and a component-specific signal compensation can thus be achieved even without a mechanical stimulus.

With reference to FIG. 5, the structure of an embodiment of the micromechanical pressure sensor 180 is described. For example, for compensating for the action of a weight force, of the gravitational acceleration, or of another acceleration, the acceleration sensor shown in FIG. 6 is assigned to the pressure sensor 180.

The structure of the pressure sensor 180 is, by way of example, composed of a substrate 100 onto which an oxide layer 110 and a poly-silicon layer 120 are applied. On this poly-silicon layer 120, the pressure sensor 180 is formed in a common layer structure 130, for example as a sequence of a plurality of poly-silicon layers and oxide layers. In the present structure, a functional layer 135 is provided, from which both the upper (movable) electrodes 150 of a capacitive measurement value detection or measurement capacitance and the upper electrodes 160 of a reference capacitance are formed. Alternatively, however, the individual electrodes may also be formed from different layers or structures. The corresponding lower (rigid) electrode 155 of the first measurement value detection and the lower electrodes 165 of the reference capacitances are applied directly onto the poly-silicon layer 120 and electrically separated from the substrate 100 by the oxide 110. Optionally, electrical connection lines for contacting the lower electrodes 155 or 165 may be arranged in the poly-silicone layer 120 or in the oxide layer 110. In the structure shown of the pressure sensor 180, the upper electrodes 150 are attached directly to the membrane 140. As a result, when the membrane 140 is loaded with pressure, the distance of the two electrodes 150 and 155 changes in such a way that a measure of the deflection of the membrane 140 can be derived from the resulting change in capacitance. The electrodes 160 and 165 of the reference capacitances, on the other hand, are designed to be independent of the movement of the membrane 140 so that interferences that act on the entire system can be detected by means of this reference capacitance.

The gel 480 is applied to the membrane 140 in order in particular to protect the structures provided on or in the membrane 140 from the medium abutting the membrane 140. However, the gel 480 additionally loads the membrane 140 with weight, which both affects the movement behavior of the membrane 140 and exerts an orientation-dependent weight force on the membrane 140 of the pressure sensor 180.

FIG. 6 shows an exemplary embodiment of the acceleration sensor 200, in which the MEMS functional structure 290 is accommodated in a separated cavern 260.

The acceleration sensor 200 according to the representation of FIG. 6 comprises a spring/mass system in the form of a rocker structure, in which a first (seismic) mass 230 and a second (seismic) mass 235 are connected to one another via a spring element 240 in such a way that the masses 230 and 235 can be moved up and/or down in the z direction 1000, i.e., perpendicularly to the membrane 140, to the functional layer 135, and to the substrate 100.

The suspension of the spring element 240 on a carrier within the cavern 260 is not shown in FIG. 6, but such structures are known from documents EP 0 244 581 B1 or EP 0 773 443 B1, for example. The spring element 240 can be designed as a flexible spring, a bending beam, or also as a torsion spring. For reasons of symmetry, the two masses 230, 235 can also be arranged on a respective own spring element, in particular on a common central beam. Alternatively, the masses may each also be connected on two sides to spring elements.

In the exemplary embodiment, FIG. 6, the second mass 235 serves as an oscillation element, which responds to an existing acceleration, in particular to the gravitational acceleration g. The second mass 235 is many times greater than the first mass 230, in particular by the factor of 2, 5, or 10. Since the second mass 235 is greater, its response to an acceleration perpendicular to the substrate 100 or the membrane 140 is more pronounced so that the first mass 230, which is operatively connected to the second mass 235 via the spring element 240, is moved in the opposite direction.

Optionally, it may be provided that the first mass 230, the second mass 235, and the spring element 240 are structured out of the functional layer 135.

In the idle phase of the pressure sensor 180, without applied pressure of a medium to the membrane 140, a deflection of the membrane 140 occurs due to the total mass of membrane 140 and gel covering, resulting in a reduction of the distance of the electrodes 150, 155 and thus in a change in capacitance. Such a deflection is not associated with any pressure change applied to the membrane 140. The objective is to bring about a compensation for this weight-dependent or, in general, acceleration-dependent interference variable. As a result of the asymmetrical design of the rocker structure of the acceleration sensor 200, the second mass 235 is moved in the same direction as the membrane 140 of the pressure sensor 180 by the gravitational acceleration g or, in general, by an applied acceleration. As a result of the rocker structure, the second sensor signal 1200 representing the interference variable can be detected through the movement of the first mass 230 in the opposite direction.

By correspondingly configuring the first and second masses or suitably selecting the mass ratio, a second sensor signal 1200 can be generated, which can be used directly as the compensation signal for the first sensor signal 1100 of the pressure sensor 180.

Alternatively, it is also possible to use the aforementioned and possibly stored compensation factor V, by which the second sensor signal 1200 is multiplied in order to use the thus obtained variable as the compensation variable.

With the exemplary embodiments of FIGS. 5 and 6, a structure is described in which the cavern 170 of the pressure sensor 180 and the cavern 265 of the acceleration sensor 200 are in particular spatially and fluidically separated from one another. In order to prevent possible excessive amplitude increases of the acceleration sensor 200 or of the spring/mass system or of the rocker structure when resonance oscillations occur, the cavern 265 of the acceleration sensor 200 can be purposefully loaded with a higher pressure than the cavern 170 of the pressure sensor 180. Exemplary pressures are <5 kPa in the cavern 170 of the pressure sensor 180 and 10-100 kPa in the cavern 265 of the acceleration sensor 200.

For this purpose, in the production process of the sensor assembly, separate apertures are, for example, introduced into the membrane 140 and into the cover 145 of the acceleration sensor 200, through which apertures the pressure within the cavities can be set individually. After setting the internal pressure of the corresponding caverns 160, 165, the apertures in the membrane 140 and in the cover 145 are sealed. It is, for example, possible that the pressure sensor 180 is, for example, sealed by means of a layer deposition method by oxide layers or nitride layers at low pressure. At a subsequent later time, at a higher ambient pressure, the cover 145 of the acceleration sensor 200 can, for example, be sealed by means of a laser reseal. The higher pressure thus present in the cavern 265 of the acceleration sensor 200 dampens the acceleration sensor 200 more so that resonance oscillations can be suppressed. However, in general, it is also possible to design the micromechanical structure of the acceleration sensor 200 such that its resonance frequency is outside, in particular above, the application range of the pressure sensor 180.

What is claimed is:

1. A membrane sensor, comprising:
a pressure sensor configured to generate a first sensor signal depending on a deflection of a pressure-loadable membrane;
an acceleration sensor configured to generate a second sensor signal depending on an acceleration acting on a MEMS functional structure; and
an evaluation circuit configured to compensate for a dependence of the first sensor signal on an acceleration force including a weight force, acting on the membrane, based on the second sensor signal, wherein the pressure sensor and the acceleration sensor are stacked one above the other in a z direction.

2. The membrane sensor according to claim 1, wherein the membrane of the pressure sensor is arranged in a plane perpendicular to the z direction, and the MEMS functional structure is configured to detect at least one acceleration component, acting in the z direction, of the acceleration acting on the MEMS functional structure.

3. The membrane sensor according to claim 1, wherein the MEMS functional structure of the acceleration sensor and the membrane of the pressure sensor are arranged superposed at least in regions.

4. The membrane sensor according to claim 1, wherein the membrane is covered by a gel in such a way that the acceleration force acting on the membrane is at least partially caused by a weight of the gel.

5. The membrane sensor according to claim 1, wherein the pressure sensor and the acceleration sensor are similar transducers and are respectively configured as capacitive transducers or piezoresistive transducers, and the evaluation circuit is configured to generate an analog sum signal of the first sensor signal of the pressure sensor and the second sensor signal of the acceleration sensor.

6. The membrane sensor according to claim 1, wherein the evaluation circuit includes a first analog front end assigned to the first sensor signal and a second analog front end assigned to the second sensor signal.

7. The membrane sensor according to claim 1, wherein the evaluation circuit includes a multiplexer for reading the first and second sensor signals at different times.

8. The membrane sensor according to claim 1, wherein the evaluation circuit is at least partially realized as an integrated circuit in an ASIC chip, and wherein the acceleration sensor is arranged in the z direction between the ASIC chip and the pressure sensor.

9. The membrane sensor according to claim 1, wherein the MEMS functional structure of the acceleration sensor includes a spring/mass system in the form of a rocker structure, in which at least one mass is connected to at least one spring element, wherein the at least one mass includes a movable electrode of a capacitive measurement value detection for detecting the acceleration acting on the MEMS functional structure).

10. A method for generating a compensated sensor signal using a membrane sensor, the comprising the following steps:
generating a first sensor signal depending on a deflection of a pressure-loadable membrane of a pressure sensor;
generating a second sensor signal depending on an acceleration acting on a MEMS functional structure of an acceleration sensor; and
generating the compensated sensor signal in that a dependence of the first sensor signal on an acceleration force including a weight force, acting on the membrane is compensated based on the second sensor signal.

11. The method according to claim 10, wherein the membrane sensor includes:
a pressure sensor configured to generate the first sensor signal depending the a deflection of the pressure-loadable membrane,
an acceleration sensor configured to generate the second sensor signal depending on the acceleration acting on the MEMS functional structure, and
an evaluation circuit configured to compensate for the dependence of the first sensor signal on the acceleration force including the weight force, acting on the membrane, based on the second sensor signal, wherein the pressure sensor and the acceleration sensor are stacked one above the other in a z direction.
